(19) United States
(12) Patent Application Publication
(10) Pub. No.: US 2013/0313495 A1
(43) Pub. Date: Nov. 28, 2013

(54) CAPSTAN COMPRISING MEANS FOR ASSESSING THE TENSION OF A LINE WOUND AROUND IT AND MEANS FOR THE AUTOMATIC SELECTION OF AT LEAST ONE SPEED AS A FUNCTION OF SAID TENSION.

(71) Applicants: Michel Chenon, Saint Malo (FR); Arnaud Chancibot, Bazouges la Perouse (FR)

(72) Inventors: Michel Chenon, Saint Malo (FR); Arnaud Chancibot, Bazouges la Perouse (FR)

(73) Assignee: Pontos, Saint Malo (FR)

(21) Appl. No.: 13/878,636

(22) PCT Filed: Oct. 11, 2011
(86) PCT No.: PCT/EP11/67750

§ 371 Date: Jul. 1, 2013

(30) Foreign Application Priority Data
Oct. 11, 2010 (FR) 1058238
Jun. 15, 2011 (FR) 1155246

(51) Int. Cl. B66D 1/74; B66D 1/22

(52) U.S. Cl. CPC B66D 1/74; B66D 1/22
USPC 254/344

(57) ABSTRACT

A capstan is provided for being secured to a sailing craft in order to tension a line attached to a sail. The capstan includes a fixed base housing a shaft and a gearbox, a barrel around which the line can be wound, the barrel being mounted such that it is capable of rotating in just one direction around the base and connected to the shaft via the gearbox. The rotation of the shaft is accompanied by rotating of the barrel about the base. The capstan includes elements for assessing the tension in the line and for selecting at least one speed when the tension exceeds a predetermined threshold. The gearbox includes an interior annulus, the annulus being mounted such that it can rotate inside the barrel against the effect of elements that apply a friction and/or elastic return force to the annulus so that it can turn in relation to the barrel when the tension is above the threshold.

### CROSS-REFERENCE TO RELATED APPLICATIONS

This application is a Section 371 National Stage Application of International Application No. PCT/EP2011/067750, filed Oct. 11, 2011, which is incorporated by reference in its entirety and published as WO 2012/049188 on Apr. 19, 2012, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the disclosure is that of the designing and manufacture of nautical equipment.

More specifically, the disclosure pertains to a capstan designed to be fixedly attached to a sailing boat to tension a line secured to a sail. This type of capstan is commonly called a winch.

### BACKGROUND OF THE DISCLOSURE

Winches are commonly used in sailing boat so that their crew can tension the lines connected to the sails.

A winch classically comprises a frame housing a driveshaft and a gearbox. A drum linked to said shaft via the gearbox is mounted rotationally on the frame.

In order to tension a line, this line is wound around the drum and then the shaft is driven rotationally by means of a lever so that the drum rotates around the frame: the line then gets wound around the drum and gets tensioned.

Essentially two types of winches are known: two-speed winches and three-speed winches.

The first gear speed is the one that enables the line to be wound at the most rapid pace. Each of the higher gear speeds respectively enable the line to be wound less rapidly than with the previous gear speed but a lower force is exerted on the lever so as to compensate for the fact that, as and when the line is wound around the winch, its tension increases.

In two-speed winches, a crew member obtains the change of gear speeds by reversing the direction of rotation of the lever.

In three-speed winches, a crew member obtains the passage from the first to the second gear speed by reversing the direction of rotation of the lever and then obtains the passage from the second to the third gear speed by pressing, as the case may be, a push-button provided for this purpose on the winch and by reversing the direction of rotation of the lever.

Present-day winches are efficient. Indeed, they make it possible to tension a line while at the same time adapting the force that has to be provided for this purpose by a crew member, given the use of a gearbox.

These winches nevertheless have some drawbacks.

Prior art winches have the drawback whereby, to get into third gear speed, it is necessary to reverse the direction of rotation of the lever and actuate the push-button provided on the winch. This operation tends to make the maneuvers more complex for the crew members when they are sailing in difficult conditions (such as a choppy sea, a congested deck, etc).

In practice, the crew members generally do not wind a line around the drum of a winch by maneuvering the lever in the first gear speed and then the second gear speed and then if necessary in the third gear speed in passing from the lower gear ratio to the higher gear ratio when their strength no longer allows them to wind the line in the lower gear ratio. In a different approach, after a certain tension is exerted on the line in first gear speed, they wind the line in passing alternately from first gear speed to second gear speed and then, when the winch offers a third gear speed, in passing alternately from the second to the third gear speed in making rotations of the lever in one direction and then the other over a range of about 30° around a starting position. This action is commonly called “pumping” in sailing jargon. This reduces the angle of play of an arm around the winch and enables the arm to exert a force on the winch in an angular range in which it is the most powerful.

In three-speed winches, the passage from pumping between the first and second gear speeds to pumping between the second and third gear speeds makes it necessary to engage the third gear speed and therefore to actuate the push-button provided for this purpose. This makes the maneuver more complicated.

The European patent application No. EP-A1-0 159 095 describes a three-speed winch in which the passage from one gear speed to the other is obtained by reversing the direction of rotation of the lever without its being necessary to act on a push-button to pass from the second gear speed to the third gear speed. According to the technique described, a clockwise rotation of the lever actuates the winch in the first gear speed, a counter-clockwise rotation of the lever actuates the winch in the second gear speed and then a clockwise rotation, once again, of the lever actuates the winch in third gear speed.

The technique described in this document has the advantage of making it possible to engage the third gear speed by a simple reversal of the direction of rotation of the lever without it being necessary to additionally actuate a push-button. However, this technique has the drawback of not allowing the crew member to pump between the first and second gear speeds and then between the second and third gear speeds.

There is therefore no existing winch that enables pumping between the first and second gear speeds and then between the second and third gear speeds through action only on the direction of rotation of the lever.

Nor do present-day winches make it possible to match the passage from pumping between the first and second gear speeds to pumping between the second and third gear speeds with the arm strength of the crew member in charge of rotating the lever of the winch.

Starting from the principle that there is always some tension in a line, the designers of prior-art winches have always proposed winches where the ratio of each gear speed is a reduction ratio.

Gear-driven transmission systems make it possible, depending on the way in which they are implemented, to obtain reduction ratios or multiplication ratios. When the ratio of a transmission is a reduction ratio, the speed at output of the transmission is lower than the input speed while the torque delivered at output is greater than the input torque. Conversely, when the ratio of a transmission is a multiplication ratio, the output speed is higher than the input speed.

In prior-art winches, the torque generated on the drum in order to wind a line thereon is therefore greater than the torque exerted by a crew member on the lever to carry out the winding, whatever the gear speed engaged.

The result of this is the speed of winding of the line in first gear speed is slow while the tension in the line is low (generally one turn of the lever corresponds to a half-turn of the drum). Thus, in practice, the crew member tensions the line around the drum by hand in pulling on the free end of the line in order to accelerate the tensioning of the line.

Present-day winches therefore cannot be used to obtain both high speeds of winding of the line and high winding torque values.

Present-day winches cannot be used for the automatic selection of a gear speed according to the tension of the line wound around the winch. The selection of a gear speed is on the contrary done systematically by a crew member who does so by modifying the direction of rotation of the lever and, if necessary, actuating a push-button. This complicates the maneuvers performed by crew members sailing in a difficult context (a choppy sea or a congested deck).

Nor does any winch make it possible to adapt the gear ratio to the tension in the line.

### SUMMARY

These goals as well as others that shall appear here below are achieved by means of a capstan or winch intended to be fixedly attached to a sailing boat in order to tension a line connected to a sail, said winch comprising:
a fixed frame housing a shaft and a gearbox;
a drum around which said line can be wound, said drum being mounted so as to be mobile in rotation in only one direction around said frame and connected to said shaft via said gearbox, the putting of said shaft into rotation being accompanied by a putting of said drum into rotation around said frame.

According to the invention, such a winch comprises means for evaluating the tension of said line and means for selecting at least one gear speed when said tension becomes above a predetermined threshold, said gearbox comprising an inner ring gear, said ring gear being mounted so as to be mobile in rotation inside said drum against the effect of means exerting a frictional force and/or an elastic return force on said ring gear so that it can rotate relative to said drum when said tension is above said threshold.

The invention therefore provides an original winch in which at least one of the gear speeds is selected automatically according to the tension in the line wound around the drum. This makes it possible to match the effort that a crew member tensioning a line must provide with his physical condition.

The technique of the invention therefore facilitates maneuvers by the crew members of a sailing boat.

Thus, when the torque exerted on the drum by the line becomes greater than the torque exerted on the ring gear by the crew member through the drive means and the gearbox and greater than the frictional force and/or return force between the ring gear and the drum, the ring gear rotates inside the drum, i.e. the ring gear or the drum rotate relatively to each other. This rotation then gives an indication on the level of tension in the line.

In this case, said means for selecting are preferably mobile between at least one resting position and one position for selecting at least one gear speed, said ring gear acting on said means for selecting automatically to place them in either one of their positions.

The rotation of the ring gear relatively to the drum, which signifies that tension in the line has reached a certain value, enables action on the selection means so that one or more suitable gear speeds, for example a third gear speed, are engaged.

A winch according to the invention preferably comprises means for converting a shift of said ring gear relative to said drum into a movement of said means for selecting either one of their positions.

This provides for precise and efficient selection in a simple way.

A winch according to the invention advantageously has means for adjusting said threshold value.

It is thus possible to adapt the winch to its user's strength by modifying the value of the threshold tension in the line from which the engagement takes place.

According to one advantageous characteristic, said ring gear has a contact surface with a ramp and said means exerting a frictional force on said drum comprise a toe interdependent with said drum and taking support on said contact surface under the effect of said elastic return means.

Thus, when the torque exerted by the line on the drum becomes greater than the frictional force of the toe on the ramp, the ring gear rotates inside the drum.

Said means for adjusting preferably comprise a screw with a base and a head, said return means being interposed between said toe and said base, said head being accessible from outside said drum.

It is thus possible to easily adjust the threshold value by acting from outside the winch on the screw provided for this purpose without any need to dismantle the winch. A winch according to the invention therefore has the advantage of being ergonomical.

In the example of a three-speed winch, if the user is strong, the threshold tension value will be great so that he will be able pump for a longer time between the first and second gear speeds. If the user is weaker, the threshold tension value will be lowered so that the passage from pumping between the first and second gear speeds to pumping between the second and third gear speeds will occur more speedily to as to bring relief to the user. This principle is applicable to winches with more than three speeds.

According to one advantageous embodiment, said ring gear has a hollow housing and said means exerting a frictional force on said drum comprise an elastic toe that is interdependent with said drum and has its end capable of getting housed in said hollow housing.

This embodiment has the advantage of being simpler to implement than the one in which the ring gear has a ramp on which a toe is acting.

According to one advantageous embodiment, said gearbox is a three-speed gearbox, said means for selecting automatically being means for selecting the third gear speed and the putting of said shaft into rotation in one direction or the other is accompanied by the putting of said drum into rotation around said frame in one speed or another.

The invention therefore proposes an original three-speed winch in which the passage from one of the gear speeds to the other is obtained by modifying the direction of rotation of the drive means, for example a lever, without any need to act additionally on the push-button. Moreover, the third gear speed is engaged automatically as soon as the tension in the line reaches a certain value. The invention thus provides a three-speed winch in which the passage from a pumping between the first and second gear speeds to a pumping between the second and third gear speeds is obtained by acting solely on the direction of rotation of the drive means.

Preferably, the first gear speed of said gearbox has a multiplication ratio, the second and third gear speeds having reduction ratios.

In a wholly original way, a winch according to the invention has a first gear speed, also called a boarding gear speed, the ratio of which is greater than 1. In other words, when the winch is actuated in first gear speed, the number of rotations made by the drum is greater than the number of rotations made by the drive means for a given number of rotations of the actuation means. A winch according to the invention can therefore wind a line around the drum more rapidly than the prior-art winches, each gear speed of which has a ratio below 1.

In advantageous embodiments, said means for selecting are means for selecting a third and a fourth gear speeds.

When the tension in the line is low, the drum could be driven rotationally in one direction in a first and a second gear speed. When the tension in the line becomes great, the drum could be driven rotationally in one direction in a third and a fourth gear speed. It will then be possible to pass from a pumping between the first and second gear speeds to pumping between the third and fourth gear speeds.

In an advantageous embodiment, said shaft comprises a first shaft portion and a second shaft portion, said second shaft portion being connected to said ring gear by a plurality of gears so that a rotation of said second shaft portion in one direction or in the other drives a rotation of said drum in one direction at two different transmission ratios, said first shaft portion being connected to at least one gear train, said means for selecting puting said first shaft portion in direct drive with said second shaft portion when they occupy one of their positions, said means for selecting puting said first shaft portion in drive with said second shaft portion via one of said gear trains when they occupy another of their positions.

When the tension in the line is low, the drum could be driven rotationally in first and second gear speeds. When the tension in the line becomes high, the drum could be driven in rotation in this direction in at least two other gear speeds. It will then be possible to pass from pumping between the first and second gear speeds to pumping between the third and fourth gear speeds. In variants, the system could be multiplied to pass if necessary from pumping between the third and fourth gear speeds to pumping between fifth and sixth gear speeds, etc.

In one advantageous embodiment, said shaft is connected to said ring gear by a plurality of gears so that a rotation of said shaft in one direction or the other drives a rotation of said drum in one direction at two different transmission ratios, said shaft being furthermore connected to the input of a multiplier gear train, the output of which is connected to the input of the plurality of gears by a one-way clutch, said means for selecting puting the output of said multiplier gear train in drive with the input of the plurality of gears when they occupy their resting position, said means for selecting not puting the output of said multiplier gear train in drive with the input of the plurality of gears when they occupy their other position.

Thus, in a simple way, the invention obtains a rotation of the drum in a first gear speed by the rotation of the shaft in one direction, a rotation of the drum in a second gear speed by the rotation of the shaft in the other direction, a rotation of the drum in a third gear speed by the rotation of the shaft in the first direction.

According to an advantageous characteristic, said shaft has a first end to which drive means can be connected, said gearbox having a first pinion connected by means of a first one-way clutch to a second end of said shaft, said first pinion meshing with a second pinion mounted so as to be rotationally mobile on a first pin interdependent with said frame, said second pinion meshing with an inner ring gear interdependent with said drum, a third pinion being interdependent with said second end of said shaft, said third pinion meshing with a fourth pinion mounted so as to be rotationally mobile around a second pin interdependent with said frame, said fourth pinion meshing with a fifth pinion connected to said first pin by means of a second one-way clutch, said winch furthermore comprising a multiplier having an input connected to said shaft and an output connected to the first pinion by means of a third one-way clutch, said means for selecting automatically being capable of taking a position for holding said third one-way clutch in disengaged position when said tension is above said threshold, the first, second and third one-way clutches being configured so that a rotation in a first direction of the shaft enables it to transmit a torque to said ring gear via said multiplier, said third one-way clutch, said first and said second pinions, so that a rotation of the shaft in another direction enables it to transmit a torque to said ring gear via the first and second pinions, and so that a rotation in said first direction of said shaft while said tension is above said threshold enables it to transmit a torque to said ring gear via the third, fourth and fifth pinions.

In this case, said ring gear is preferably mounted so as to be mobile in rotation between two end positions inside said drum, countering the effect of said elastic return means, said ring gear acting on said means for selecting automatically so that the passage from one of said end positions to the other, countering the effect of said return means, is accompanied by the passage of said means for selecting into said holding position.

According to an advantageous characteristic, said multiplier, said third one-way clutch and said means for selecting automatically are detachable.

The dismantling of these elements makes it possible to obtain a classic two-speed winch. A winch according to the invention therefore has a modular design which reduces its cost of manufacture.

According to an advantageous characteristic, a winch according to the invention comprises means for actuating said shaft, said actuating means comprising a coffee grinder or a lever, one end of which is complementary to said first end of said shaft.

It is thus possible to provide a winch according to the invention with a lever and to place it in a position in which its shaft extends essentially vertically so that it constitutes a winch. It is also possible to provide it with a coffee grinder and to place it in a position in which its shaft extends essentially horizontally, so that it constitutes a coffee grinder or a pedestal.

### BRIEF DESCRIPTION OF THE DRAWINGS

Other features and advantages of the invention shall appear more clearly from the following description of a preferred embodiment, given by way of a simple illustratory and non-exhaustive example and from the appended drawings, of which:

FIG. 1 presents a front view of a winch according to the invention;

FIG. 2 illustrates a view in longitudinal section of the winch illustrated in FIG. 1;

FIG. 3 illustrates a view in section along the axis C-C of the winch illustrated in FIG. 2;

FIG. 4 illustrates a view in section along the axis D-D of the winch illustrated in FIG. 2;

FIG. 5 illustrates a view in section along the axis E-E of the winch illustrated in FIG. 2;

FIG. 6 illustrates a view in section along the axis F-F of the winch illustrated in FIG. 2;

FIG. 7 illustrates a view in section along the axis H-H of the winch illustrated in FIG. 2;

FIGS. 8 and 9 illustrate views in perspective of the winch illustrated in FIG. 2 in which the drum is represented only partially;

FIGS. 10 and 11 illustrate two views in longitudinal section of a second embodiment of a winch according to the invention;

FIG. 12 illustrates a view in section along the axis F-F of the winch illustrated in FIG. 10;

FIG. 13 illustrates a view in section along the axis G-G of the winch illustrated in FIG. 11;

FIG. 14 illustrates a view in perspective of a second clutch element of a winch according to the second embodiment;

FIG. 15 illustrates a view in section along the axis C-C of the winch illustrated in FIG. 10;

FIG. 16 illustrates a view in section along the axis D-D of the winch illustrated in FIG. 10;

FIG. 17 illustrates a view in section along the axis E-E of the winch illustrated in FIG. 11;

FIG. 18 illustrates a view in perspective of a second shaft portion of a winch according to the second embodiment;

FIG. 19 illustrates a front view of a winch according to a third embodiment of the invention;

FIGS. 20 and 21 illustrate two views in section along the axis A-A of the winch illustrated in FIG. 19;

FIG. 22 illustrates a view in section along the axis E-E of the winch illustrated in FIG. 19;

FIG. 23 illustrates a view in section along the axis B-B of the winch illustrated in FIG. 19;

FIG. 24 illustrates a view in section along the axis C-C of the winch illustrated in FIG. 20;

FIG. 25 illustrates a view in section along the axis C-C of the winch illustrated in FIG. 20.

### DETAILED DESCRIPTION OF ILLUSTRATIVE EMBODIMENTS

### 1. Description of One Embodiment of the Invention

1.1. Reminder of the Principle of the Invention

The general principle of the invention relies on the implementing of a winch with several speeds that is to be fixedly attached to a sailing boat to tension a line connected to a sail, the winch comprising means for evaluating the tension of a line wound around it and means for selecting at least one gear speed when the tension becomes above a predetermined threshold.

The invention therefore provides an original winch in which at least one of the speeds is selected automatically as a function of the tension in the line wound around the drum. This makes it possible to adapt the force to be provided by a crew member tensioning a line to his physical condition.

The technique according to the invention therefore facilitates the maneuvers of the crew members of a sailing boat.

1.2. Example of a First Embodiment of a Winch According to the Invention

1.2.1. Architecture

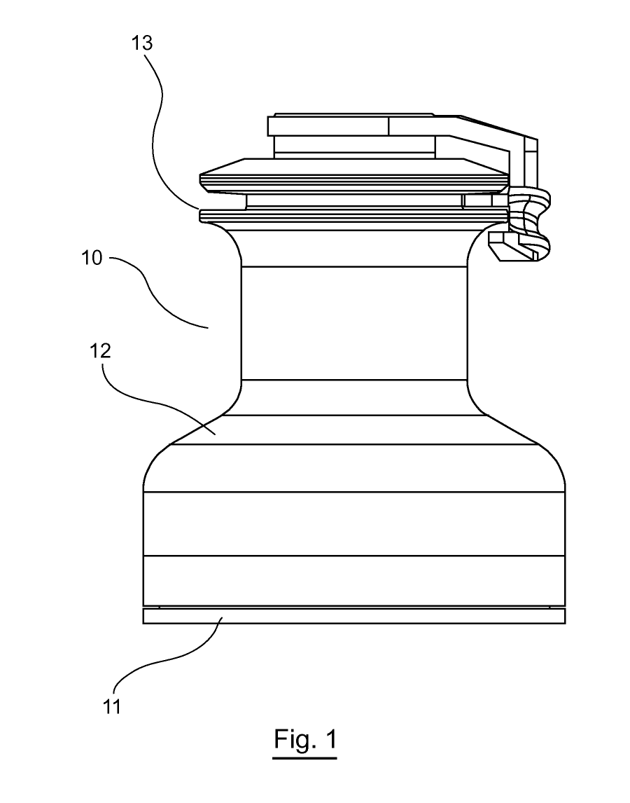

FIG. 1 illustrates a front view of a winch 10 according to the invention. Such a winch 10 comprises a frame 11 on which there is mounted a drum 12 that is mobile in rotation. The frame 11 is to be fixedly attached for example to the deck of a sailing boat. A line, one end of which is connected to a sail of the sailing boat, can be wound around the drum 12. This winch 10 classically comprises a device 13 for reversibly capturing one end of the line that has to be wound around the drum 12.

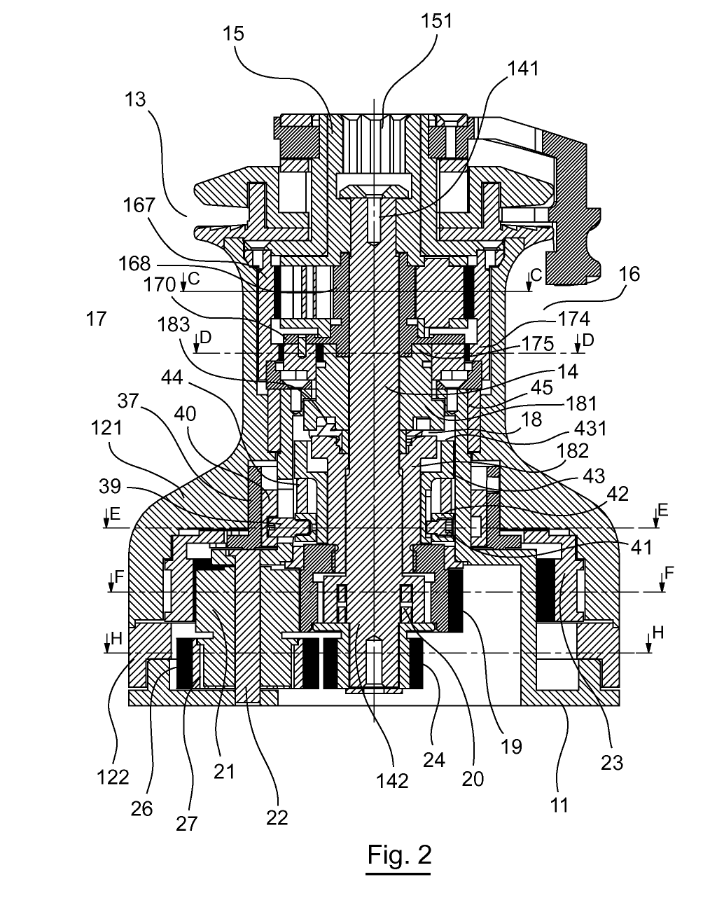

FIG. 2 is a view in section of the winch 10 illustrated in FIG. 1.

As can be seen in this FIG. 2, the drum 12 comprises an upper drum element 121 and a lower drum element 122.

The winch comprises a shaft 14 mounted rotationally in the frame 11. The shaft 14 comprises an upper end 141. This upper end 141 is interdependent with the input 15 of the winch. The input 15 has a splined portion 151 which is designed to cooperate with means for actuating the winch. These actuating means may comprise a lever. In one variant, they could comprise a “coffee grinder”. The drive means could also be motor-driven.

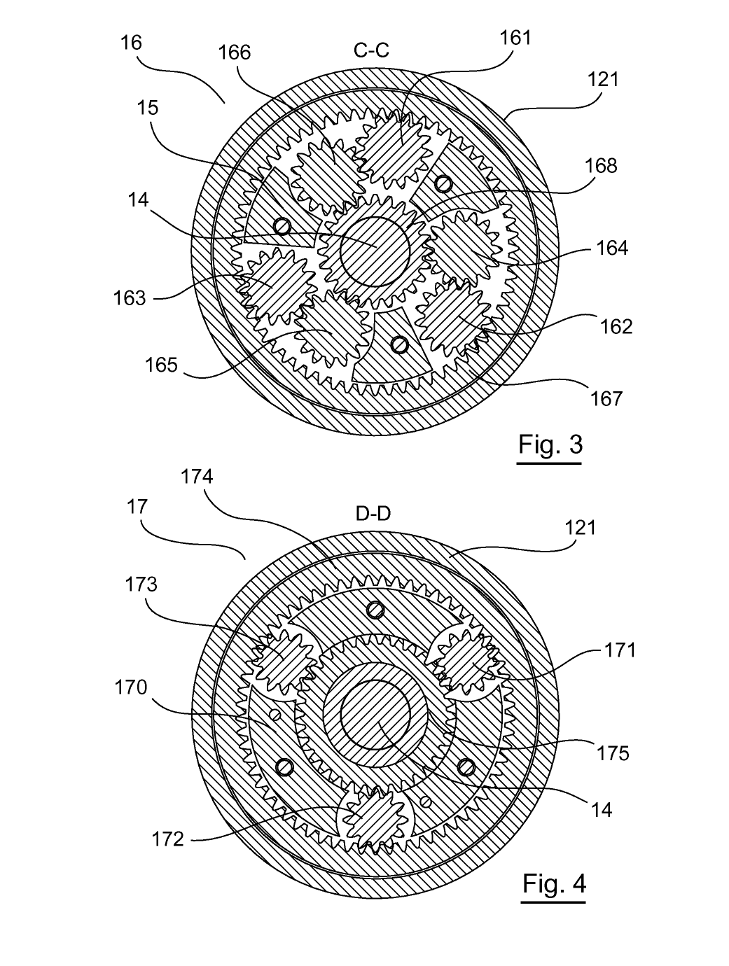

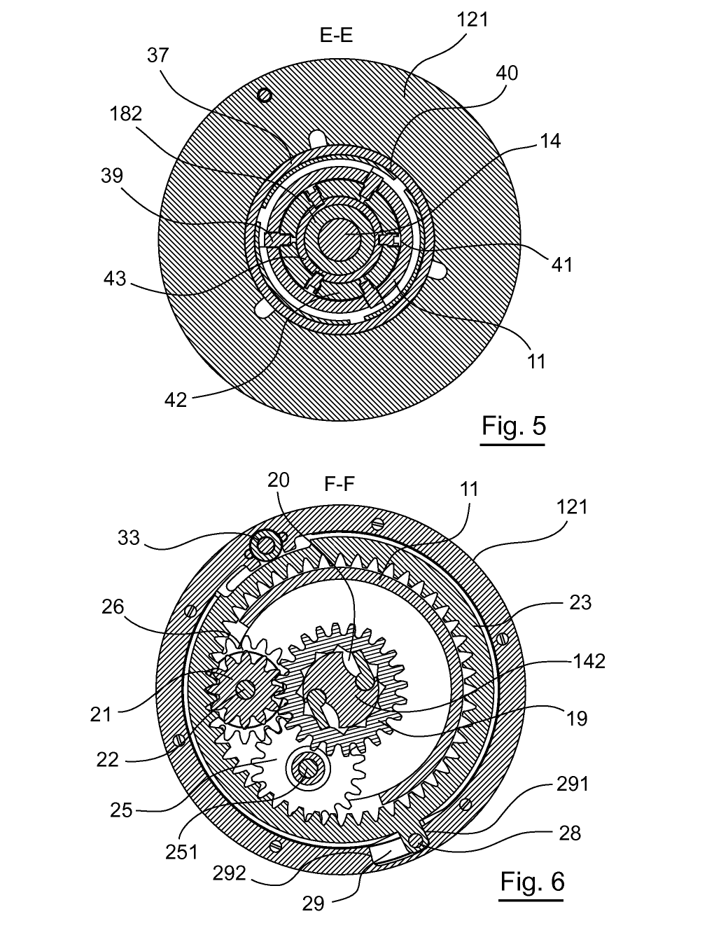

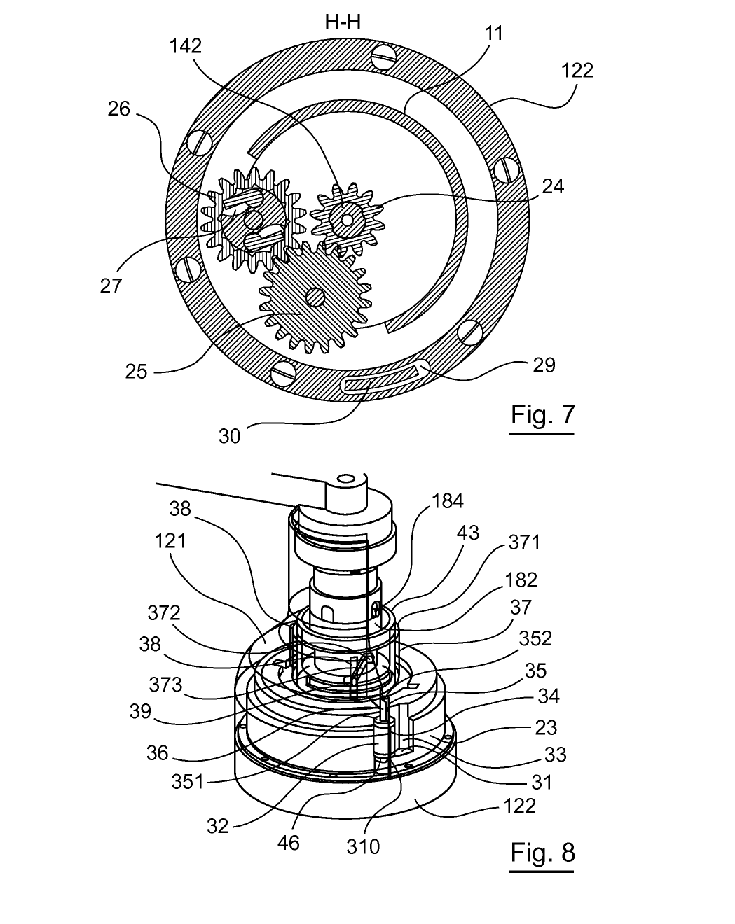

The input 15 constitutes the planet carrier of a first epicyclic gear train 16 (cf. FIG. 3). This first epicyclic train 16 comprises six planet gears 161, 162, 163, 164, 165, 166, a fixed ring gear 167 and a sun gear 168. This first epicyclic gear train 16 fulfils the function of an inverter as shall be explained in greater detail here below.

The sun gear 168 is interdependent with the planet carrier 170 of a second epicyclic gear train 17 (cf. FIG. 4). This second epicyclic gear train 17 comprises three planets 171, 172, 173, a fixed ring gear 174 and a sun gear 175. The second epicyclic train 17 fulfils the function of a multiplier as shall be explained in greater detail here below.

The sun gear 175 is interdependent with the first element 181 of a one-way clutch 18. This one-way clutch 18 has a second element 182. The first element bears ratchets 183 that are mobile between an interlocked position in which they cooperate with the second element 182 so that the first element 181 and second element 182 are linked to the rotation and a released position in which the first element 181 and second element 182 are not linked to the rotation.

The second element 182 is interdependent with a first pinion 19.

The shaft 14 has a lower end 142. The first pinion 19 is interdependent with the lower end 141 of the shaft 14 by means of another one-way clutch 20.

The first pinion 19 meshes with a second pinion 21 mounted rotationally on a pin 22 interdependent with the frame 11.

The second pinion 21 meshes with an inner ring gear 23 interdependent with the interior of the upper drum element 121.

A third pinion 24 is fixedly attached beneath the first pinion 19 to the lower end 142 of the shaft 14. This third pinion 24 meshes with a fourth pinion 25 mounted so as to be rotationally mobile about a pin 251 interdependent with the frame 11. This fourth pinion 25 meshes with a fifth pinion 26 which is mounted so as to be rotationally mobile about the pin 22. The fifth pinion 26 is connected to the second pinion 21 by means of another one-way clutch 27.

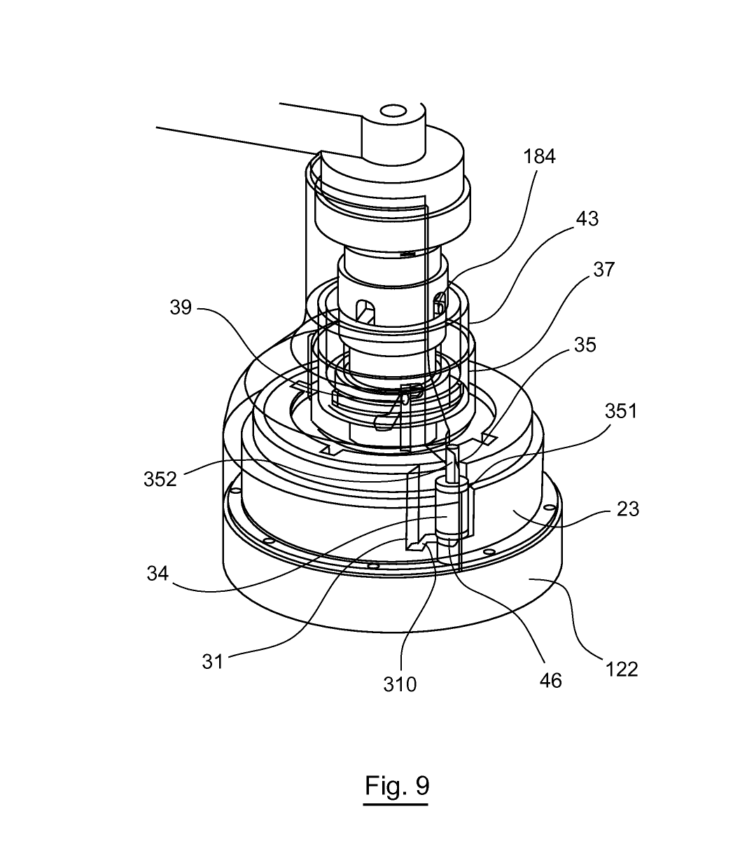

The ring gear 23 is mounted so as to be rotationally mobile within the upper drum element 121. The ring gear 23 comprises a peg 28 projecting out from its periphery. This peg 28 extends into a cavity 29 in an arc of a circle made in the lower drum element 122. This cavity 29 houses a compression spring 30. The ring gear 23 is therefore rotationally mobile inside the upper drum element 121 between two end positions:
a first position, illustrated in FIGS. 6 and 8, in which the compression spring 30 is released so that the peg 28 abuts against an end 291 of the cavity 29;
a second position, illustrated in FIG. 9, in which the compression spring 30 is compressed between the peg 28 and another end 292 of the cavity 29 under the effect of the rotation of the ring gear 23 inside the upper drum element 121.

The ring gear 23 comprises a contact surface 31 having a ramp 310.

The upper drum element 121 has a cavity 32. The ring gear 23 also has a cavity 33, the bottom of which is constituted by the contact surface 31. The cavities 32 and 33 house a toe 46 which is mounted so as to be mobile in translation along an axis parallel to the axis of the shaft 14. This toe 46 has a ramp with a shape complementary to the ramp 310 of the contact surface 31. It is held so as to be supported against the contact surface 31 by means of a compression spring 34 which is interposed between the toe 46 and the base 351 of a screw 35 which is housed in a thread 36 made in the upper drum element 121. The head 352 of this screw 35 is accessible from the exterior of the drum.

A lifting element 37 is housed in a housing of a complementary shape made in the ring gear 23 so that the lifting element 37 and the ring gear 23 are connected rotationally.

The lifting element 37 has a cylindrical portion 371 which extends above the ring gear 23. Three apertures 372 are made and distributed uniformly in the cylindrical portion 371. These apertures 372 are inclined so that they constitute ramps 373.

Three grooves 38 are made and distributed uniformly inside the upper drum element 121. They extend in parallel to the axis of the shaft 14.

Three lifting pegs 39 extend inside the grooves 38 and the apertures 372. They are interdependent with a transition ring 40 mounted so as to be mobile in translation inside the cylindrical portion 371 along the axis of the shaft 14.

The transition ring 40 is connected by pins 41 to a lifting ring 42. The pins 41 pass through apertures which are made to this effect in the frame 11 and which extend along an axis parallel to the axis of the shaft 14.

A pusher element 43 is mounted so as to be sliding along the second element 182. A compression spring 44 is interposed between the lifting ring 42 and the pusher element 43.

The pusher element 43 has a collar 431 at its upper part designed to cooperate with the ends 184 of the ratchets 183 of the one-way clutch 18.

A ball bearing 45 is interposed between the frame 11 and the upper drum element 121 so as to rotationally guide the drum 12 relatively to the frame 11.

1.2.2. Operation

A splined part of actuating means, such as a lever or coffee grinder, is introduced into the splined part 151 of the input 15 of the winch.

A crew member can then wind a line around the drum 12 at three different gear speeds in rotationally driving the drive means.

A. First Gear Speed

When the drive means, which cooperate with the splined portion 151, are driven rotationally in the clockwise direction, the shaft 14 rotates in the clockwise direction. The sun gear 168 is driven rotationally via the planet gears 161, 162, 163, 164, 165, 166 in the counter-clockwise direction. The planet carrier 170 then rotates in the counter-clockwise direction. The sun gear 175 is driven via the sun gears 171, 172, 173 in the counter-clockwise direction at a speed greater than the speed of rotation of the shaft 14.

The first element 181 of the one-way clutch element 18 which is interdependent with the sun gear 173 also rotates in the counter-clockwise direction. The ratchets 183 cooperate with the second one-way clutch element 182 so that it rotates in the counter-clockwise direction. The first pinion 19 which is interdependent with the second one-way clutch element 18 is then driven in rotation in the counter-clockwise direction. The second pinion 121 rotates in the clockwise direction and drives the ring gear 23 in this direction. The drum 12 then rotates around the frame 11 in the clockwise direction. In this case, the one-way clutches 20 and 27 respectively linking the first pinion 19 to the shaft 14 and the second pinion 21 to the fifth pinion 26 rotate in neutral.

When the force that a crew member must apply to the drive means to continue the winding of the line around the drum becomes far to great because of the tension of the line, a second gear speed can be used.

B. Second Gear Speed

The passage from first gear speed to second gear speed is obtained by inverting the direction of rotation of the actuation means.

The input 15 of the winch and the shaft 14 then rotate counter-clockwise. The sun gear 168 is driven rotationally via the planet gears 161, 162, 163, 164, 165, 166 in the clockwise direction. The planet carrier 170 then rotates in the clockwise direction. The sun gear 175 is driven via the planet gears 171, 172, 173 in the clockwise direction at a speed greater than the rotation speed of the shaft 14.

The first element 181 of the one-way clutch element 18, which is interdependent with the sun gear 175, also rotates in the clockwise direction. The ratchets 183 no longer cooperate with the second element 182 of the one-way clutch 18 so that it is not linked in rotation with the first element 181 of the one-way clutch 18. The first pinion 19 is then driven rotationally in the counter-clockwise direction via the one-way clutch element 19. The second pinion 21 rotates in the clockwise direction and drives the ring gear 23 in this direction. The drum 12 then rotates around the frame 11 in the clockwise direction. In this case, the one-way clutch 27 linking the second pinion 21 to the fifth pinion 26 rotates in neutral.

When the force that a crew member has to apply to the drive means to continue the winding of the line around the drum becomes far too great because of the tension of the line, a third gear speed can be used.

C. Third Gear Speed

C.1/Selection

When the force applied to the drum 12 by the line wound around it becomes greater than the sum of the force applied to the drum 12 by the crew member through the actuating means and the different gears by which they are linked to the ring gear 23 and of the frictional force exerted by the toe 46 via the compression spring 34 on the contact surface 31 of the ring gear 23, the ring gear 23 rotates inside the upper drum element 121 against the effect of the compression spring 30 until it reaches its second end position in which the peg 28 completely compresses the spring 30 against the end 292 of the cavity 29. The ring gear 23 passes from its first end position illustrated in FIG. 8 to its second end position illustrated in FIG. 9.

During its rotation in the clockwise direction relative to the upper drum element 121, the ring gear 23 rotationally drives the lifting element 37. The lifting pegs 39 then shift inside the apertures 372 and rise in the grooves 38. The transition ring 40 interdependent with the lifting pegs 39 follow the same motion, just like the lifting ring 42. The lifting ring 42 acts on the pusher element 43 via the compression spring 44. The collar 431 then acts on the ends 184 of the ratchets 183 of the one-way clutch 18. These ratchets 183 are then held in their position in which they do not cooperate with the second element 182 of the one-way clutch 18. The first element 181 and second element 182 of the one-way clutch 18 are then not linked in rotation.

The third gear speed is thus selected. However, so long as the crew member continues to make the actuating means rotate in the counter-clockwise direction, the winch will be implemented at the second gear speed, the third gear speed being pre-selected.

C.2/Engaging Gear Speeds

When the crew member feels that the force that he must provide in the second gear speed to wind the line becomes excessive, he obtains a shift into third gear speed by again reversing the direction of rotation of the activation means.

The input 15 of the winch then rotates in the clockwise direction. Since the first 181 one-way clutch element and second 182 one-way clutch element are not rotationally linked, the shaft 14 rotationally drives the third pinion 24 in the clockwise direction. The fourth pinion 25 then rotates in the counter-clockwise direction while the fifth pinion 26 rotates in the clockwise direction. The fifth pinion 26 rotationally drives the second pinion 21 in the clockwise direction by means of the one-way clutch 27. The ring gear 23 rotates in this direction. The drum 12 then rotates around the frame 11 in the clockwise direction. In this case, the one-way clutch 20 linking the first pinion 19 to the second pinion 21 rotates in neutral.

C.3/Adjustment of Selection of Third Gear Speed

The value of the force applied by the line to the drum that enables the selection of the third gear speed can be adjusted. This adjustment is obtained by driving in the screw 35 to a greater or lesser extent into the thread 36 of the drum 12. The further the screw 35 is tightened into the thread 36, the greater the tensional force needed in the line in order that the third gear speed may be selected. Conversely, the lesser the extent to which the screw 35 is tightened into the thread 36, the lower is the tensional force needed in the line in order that the third gear speed may be selected.

The tension in the line after which the third gear speed will be selected could therefore be adjusted as a function of the physical capacities of the crew member having to handle the winch.

If the crew member is in average physical condition, the adjustment could be done in such a way that the force he must furnish to wind the line in second gear speed before selecting the third gear speed is of an average level. If the crew member is in better physical condition, the adjustment could be done in such a way that he must bring greater force to winding the line in second gear speed before the third gear speed is selected.

C.4/Deselection

When the line is released, the ring gear 23 returns to the first end position under the effect of the compression spring 30 and the pusher element 43 resumes its initial position so that when the drive means are driven in the clockwise direction, the winch will rotate in first gear speed.

1.2.3. Use in Pumping Mode

The winch 10 can be used in pumping mode by a crew member. In this case, the crew member rotationally drives the lever in one direction and then in the other so as to move the lever by about 30° on either side from an initial position. He then places the line under tension in pumping between the first and second gear speeds.

As soon as the tension in the line is such that the third gear speed is selected, the crew member tensions the line in pumping between the second and third gear speeds.

The winch according to the invention therefore makes it possible to pass:
from one gear speed to the other;
from pumping between the first and second gear speeds to pumping between the second and third gear speeds,
in modifying only the direction of rotation of the lever.

The fact of being able to adjust the threshold value of tension from which third gear speed is engaged makes it possible to match the level of force from which the winch will pass from pumping between the first and second gear speeds to pumping between second and third gear speeds to the crew member's strength.

In this first embodiment, the gearbox is a three-speed gearbox and said means for selecting automatically are means for selecting the third gear speed, the rotating of the shaft in one direction or in the other being accompanied by a rotating of said drum around said frame in one gear speed or another.

The invention therefore proposes an original three-speed winch in which the passage from one of the gear speeds to the other is obtained by modifying the direction of rotation of the drive means, for example a lever, without its being necessary to act additionally on a push-button.

Furthermore, the third gear speed is automatically engaged as soon as the tension in the line reaches a certain value. The invention thus provides a three-speed winch in which the passage from pumping between the first and second gear speeds to pumping between the second and third gear speeds is obtained by acting only on the direction of rotation of the drive means.

1.3. Example of a Second Embodiment of a Winch According to the Invention

1.3.1. Architecture

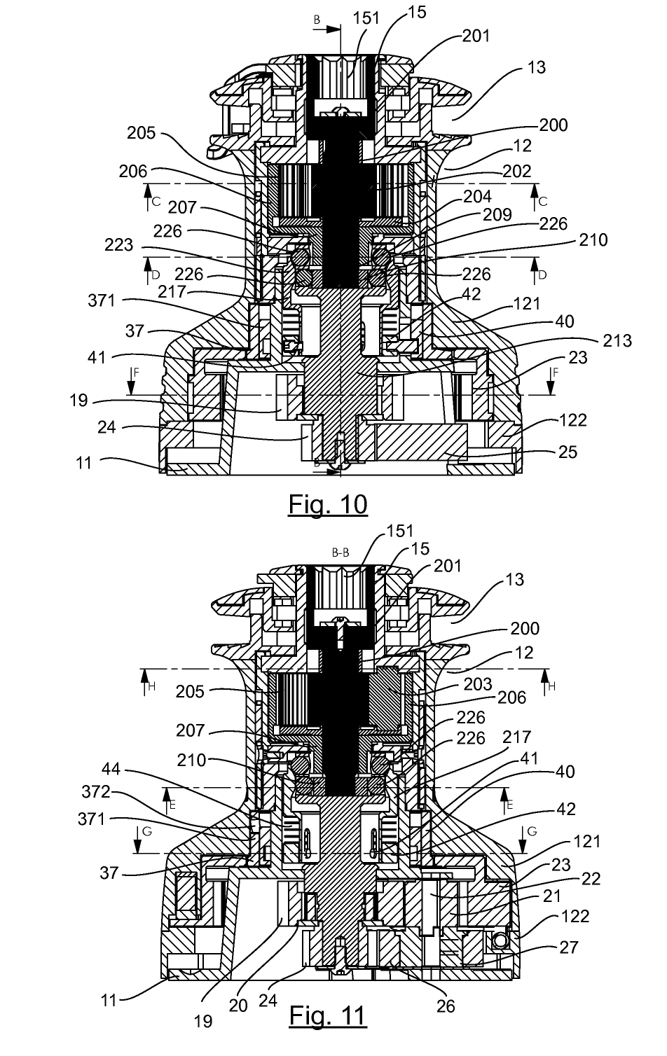

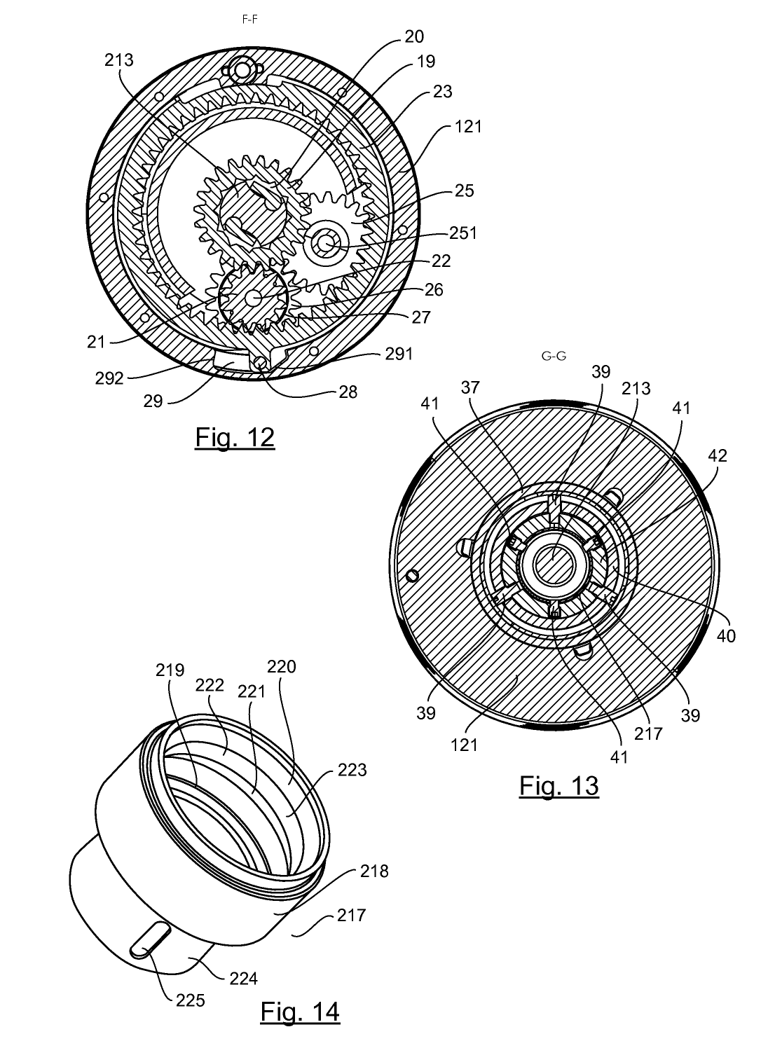

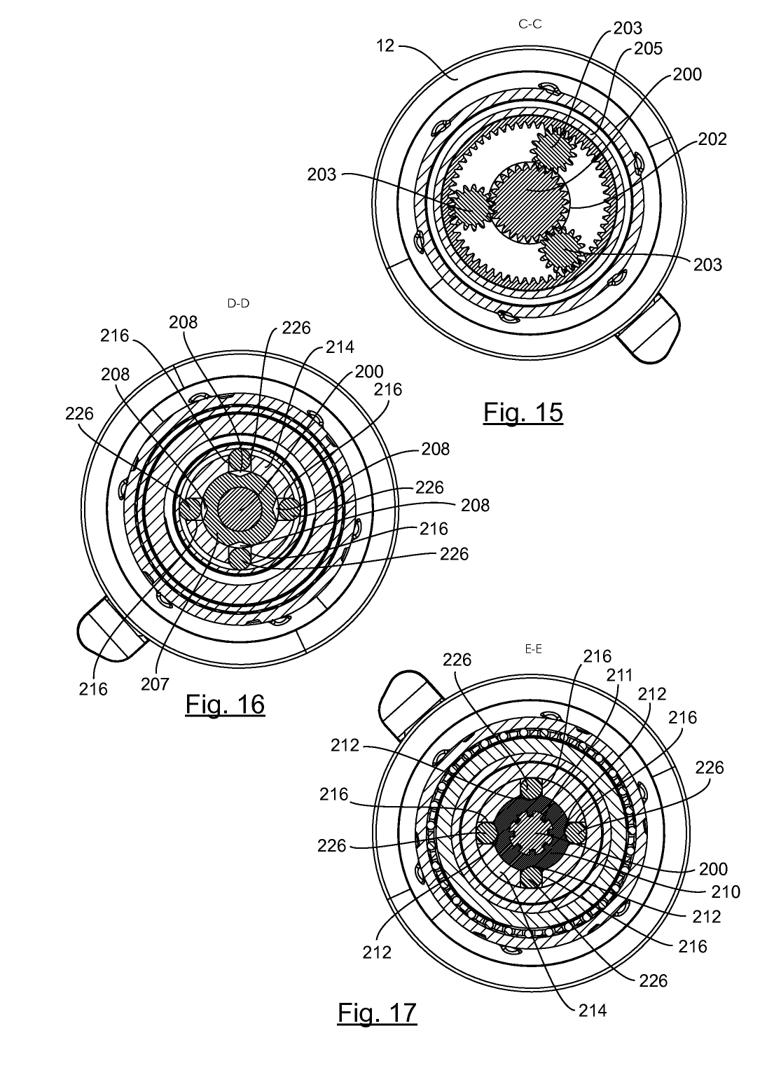

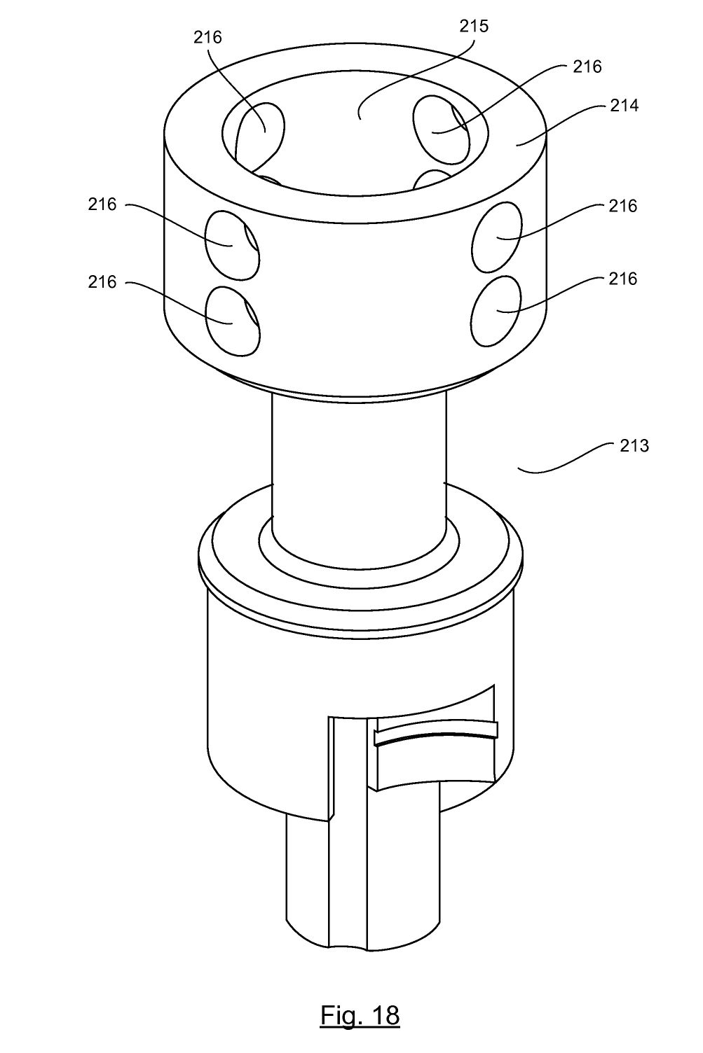

FIGS. 10 and 11 illustrate two views in longitudinal section of a winch according to a second embodiment.

Such a winch 10 comprises a frame 11 on which a drum 12 is mounted so as to be mobile in rotation. The frame 11 is to be fixedly attached for example to the deck of a sailing boat. A line, one end of which is linked to a sail of the sailing boat, can be wound around the drum 12. This winch 10 classically comprises a device 13 for reversibly capturing one end of the line that has to be wound around the drum 12.

The drum 12 comprises an upper drum element 121 and a lower drum element 122.

The winch comprises a first shaft portion 200 mounted so as to be mobile in rotation in the frame 11. The first shaft portion 200 comprises one upper end 201. This upper end 201 is interdependent with the input 15 of the winch. The input 15 has a splined portion 151 designed to cooperate with means for actuating the winch. These means of actuation can comprise a lever. In one variant, they could comprise a “coffee grinder”. The drive means could also be motor-driven.

The first shaft portion 200 has a pinion which constitutes the sun gear 202 of an epicyclic train. The sun gear 202 meshes with three planet gears 203 which are mounted on a planet carrier 204 mounted rotationally on the first shaft portion 200. The planet gears 203 mesh with an inner toothed wheel 205. The epicyclic train is herein a reduction gear. In one variant, it could be a multiplier.

In one variant in which the epicyclic train is a multiplier, when the winch is actuated in first gear speed, the number of rotations made by the drum is greater than the number of rotations made by the drive means for a given number of rotations of the actuating means. A winch according to the invention therefore enables a line to be wound around the drum more speedily than with the prior-art winches, for which each gear speed has a ratio lower than 1. This winch is particularly well suited to sheet, genoa and mainsail winches. It enables tacking maneuvers without any need to grasp the sheet by hand for boarding.

In one variant, in which the epicyclic train is a reduction gear, when the epicyclic train is a reduction gear, the third and fourth gear speeds have reduction ratios of over 50% relative to the reduction ratios of the first and second gear speeds. A winch according to the invention therefore makes it possible to wind a line around the drum with half the effort of prior-art winches for which each gear speed has a reduction ratio that is lower by 50%. This winch is particularly well suited for use as a halyard winch which sails are hoisted to the mast-head. The forces to be applied to the drive means are particularly great, at the end of the hoisting, especially because of the weight of the mainsail and the friction of the mainsail tracks. It is then often necessary to implement means for electrically driving the winches. The implementing of a reduction gear offers an alternative to electric winches.

The toothed wheel 205 interdependent with the first clutch element 206 mounted so as to be mobile in rotation on the first shaft portion 200.

The first clutch element 206 comprises a lower cylindrical extension 207. Four housings 208 are made longitudinally on the peripheral surface of the extension 207. They are distributed uniformly.

The first shaft portion 200 comprises a lower portion 209. A clutch ring 210 is interdependent with the lower end of the lower portion 209 by means of grooves 211 of a complementary shape made in the first shaft portion 200 and in the clutch ring 210. Four housings 212 are made longitudinally on the peripheral surface of this clutch ring 210. They are distributed uniformly.

The winch comprises a second shaft portion 213. This second shaft portion 213 is mounted so as to be mobile in rotation in the frame 11 and extends in the prolongation of the first shaft portion 200.

The second shaft portion 213 comprises a part forming a bell 214 at its upper end. The bell 214 defines an inner housing 215 within which there are housed the lower cylindrical extension 207 and the clutch ring 210.

The peripheral surface of the bell 214 is crossed by four series of two drilled holes 216. The series are distributed uniformly around the bell 214. The drilled holes 216 of each series extend along an axis parallel to the longitudinal axis of the second shaft portion 213. There are thus two rows of drilled holes 216.

A first pinion 19 is mounted at the lower end of the second shaft portion 213 by means of a one-way clutch 20.

The first pinion 19 meshes with a second pinion 21 mounted rotationally on a pin 22 interdependent with the frame 11.

The second pinion 21 meshes with an inner ring gear 23 interdependent with the interior of the upper drum element 121.

A third pinion 24 is fixedly attached beneath the first pinion 19 to the lower end of the second shaft portion 213. This third pinion 24 meshes with a fourth pinion 25 mounted so as to be mobile in rotation around a pin 251 interdependent with the frame 11. This fourth pinion 25 meshes with a fifth pinion 26 which is mounted so as to be mobile in rotation on the pin 22. The fifth pinion 26 is connected to the second pinion 21 by means of another one-way clutch 27.

In the same way as in the first embodiment, the ring gear 23 is mounted so as to be mobile in rotation inside the upper clutch element 121. The ring gear 23 comprises a peg 28 projecting from its periphery. This peg 28 is extended into a cavity 29 in an arc of a circle made in the lower drum element 122. This cavity 29 houses a compression spring 30. The ring gear 23 is therefore mobile in rotation inside the upper drum element 121 between two end positions:
a first position, illustrated in FIGS. 6 and 8, in which the compression spring 30 is relaxed so that the peg 28 abuts one end 291 of the cavity 29;
a second position, illustrated in FIG. 9, in which the compression spring 30 is compressed between the peg 28 and another end 292 of the cavity 29 under the effect of the rotation of the ring gear 23 inside the upper drum element 121.

The ring gear 23 comprises a contact surface 31 having a ramp 310.

The upper drum element 121 has a cavity 32. The ring gear 23 also has a cavity 33, the bottom of which is constituted by the contact surface 31. The cavities 32 and 33 house a toe 46 which is mounted therein so as to be mobile in translation along an axis parallel to the axis of the first shaft portion 200. This toe 46 has a ramp with a shape complementary to that of the ramp 310 of the contact surface 31. It is kept supported against the contact surface 31 by means of a compression spring 34 which is interposed between the toe 46 and the base 351 of a screw 35 which is housed in a thread 36 made in the upper drum element 121. The head 352 of this screw 35 is accessible from the exterior of the drum.

An lifting element 37 is housed in a housing of a complementary shape made in the ring gear 23 so that the lifting element 37 and the ring gear 23 are linked in rotation.

The lifting element 37 has a cylindrical portion 371 which extends above the ring gear 23. Three apertures 372 are made and distributed uniformly in the cylindrical portion 371. These apertures 372 are inclined so that they constitute ramps 373.

Three grooves 38 are made and distributed uniformly inside the upper drum element 121. They extend in parallel to the axis of the first shaft portion 200.

Three lifting pegs 39 extend within the grooves 38 and apertures 372. They are interdependent with a transition ring 40 mounted so as to be mobile in translation inside the cylindrical portion 371 along the axis of the first shaft portion 200.

The transition ring 40 is linked by shafts 41 to a lifting ring 42. The shafts 41 pass through apertures made for this purpose in the frame 11 and extending in an axis parallel to the axis of the first shaft portion 200.

A second clutch element 217 is mounted so as to be sliding along the second shaft portion 213.

At its upper part, the second clutch element 217 has a part forming a bell 218. The bell 218 defines an internal housing 219 designed to house the bell 214 of the second shaft portion 213.

The inner surface of the bell 218 of the second clutch element 217 has two ramps 220, 221 that have inverse inclinations and are joined by a plane surface 222 parallel to the axis of the first shaft portion 200. The ramps 220, 221 as well as the plane surface 222 define an element 223 forming a projection inside the bell 218.

The bell 218 is extended by a hollow cylindrical lower portion 224, the outline of which is crossed by three oblong apertures 225. The oblong apertures 225 are uniformly distributed and extend along axes parallel to the axis of the second shaft portion 213.

A compression spring 44 is mounted between the second clutch element 217 and the lifting ring 42.

The shafts 41 can slide inside oblong apertures 225.

Each drilled hole 216 houses a ball 226.

The second clutch element 217 is mobile between two positions:
a first position in which the projecting element 223 acts on the first row of balls 226, i.e. the lower row, so that they are housed in the housings 212 of the clutch ring 210 and so that the first shaft portion 200 and the second shaft portion 213 are linked in rotation;
a second position in which the projecting element 223 acts on the second row of balls 226, i.e. the upper row, so that they are housed in the housings 208 of the extension 207 and so that the extension 207 and the second shaft portion 213 are linked in rotation.

In the first position, the projecting element 223 does not act on the second row of balls. In the second position, the projecting element does not act on the first row of balls.

Ball bearings are interposed between the frame 11 and the upper drum element 121 so as to ensure the guidance in rotation of the drum 12 relative to the frame 11.

1.3.2. Operation

A splined part of actuating means, such as a lever or a coffee grinder, are introduced into the splined part 151 of the input 15 of the winch.

A crew member can then wind a line around the drum 12 at several different gear speeds in driving the drive means rotationally.

A. First Gear Speed

At the start of the winding of a line around the drum, the tension exerted by the line on the drum is low so that the ring gear 23 occupies its first position and the second clutch element 217 occupies its first position.

When the drive means which cooperate with the splined portion 151 are driven rotationally in the counter-clockwise direction, the first shaft portion 200 rotates in the counter-clockwise direction. The first clutch element 206 is driven in rotation around the first shaft portion 200 in the clockwise direction via the sun gear 202, the planet gears 203 and the inner toothed wheel 205.

Because the second clutch element 217 occupies its first position, the first clutch element 206 is not interlocked with the second shaft portion 213.

The clutch ring 210 is interlocked with the second shaft portion 213 because the second clutch element acts on the balls 226 of the first row so that they are housed in the corresponding housings 212 of the clutch ring 210. The second shaft portion 213 is therefore driven rotationally in the counter-clockwise direction.

The first pinion 19 is driven rotationally in the counter-clockwise direction via the one-way clutch 20.

The second pinion 21 is driven rotationally in the clockwise direction by the first pinion 19.

The internal ring gear 23 is driven rotationally in the clockwise direction by the second pinion 21. The drum then rotates in the clockwise direction in a first gear speed. In this embodiment, the ratio of reduction of the first gear speed is equal to 0.5. In variations, it could be different.

The third pinion 24 is driven rotationally in the counter-clockwise direction by the second shaft portion 213. The fourth pinion 25 is driven rotationally in the clockwise direction by the third pinion 24. The fifth pinion 26 is driven rotationally in the counter-clockwise direction by the fourth pinion 25. The rotational motions of the fifth pinion 26 and the second pinion 21 are disengaged owing to the implementation of the one-way clutch 27.

B. Second Gear Speed

When the force to be conveyed to the drive means becomes far too great, the crew member can reverse the direction of rotation of the drive means to go into second gear speed. The crew member then drives the drive means rotationally in the clockwise direction.

The first shaft portion 200 is driven rotationally in the clockwise direction. The second clutch element 217 still occupies its first position, the second shaft portion 213 is also driven rotationally in the clockwise direction.

The third pinion 24 is driven rotationally in the clockwise direction by the second shaft portion 213.

The fourth pinion 25 is driven in the counter-clockwise direction by the third pinion 24.

The fifth pinion 26 is driven rotationally in the clockwise direction by the fourth pinion 25.

The second pinion 22 is driven rotationally in the clockwise direction via the fifth pinion 26 and the one-way clutch 27.

The drum then rotates in the clockwise direction at a second gear speed. In this embodiment, the reduction ration of the second gear speed is equal to 0.167. In variants, it could be different.

The first pinion 19 is driven rotationally in the counter-clockwise direction by the second pinion 22. The rotational motions of the first pinion 19 and the first shaft portion 213 are disengaged owing to the implementation of the one-way clutch 20.

C. Selection

When the force applied to the drum 12 by the line wound around it becomes greater than the sum of the force applied to the drum 12 by the crew member via the drive means and the different gears by which they are linked to the ring gear 23 and of the frictional force exerted by the toe 46 via the compression spring 34 on the contact surface 31 of the ring gear 23, the ring gear 23 rotates inside the upper drum element 121 against the effect of the compression spring 30 until it reaches its second end position in which the peg 24 completely compresses the spring 30 against the end 292 of the cavity 29. The ring gear 23 passes from its first end position illustrated in FIG. 8 to its second end position illustrated in FIG. 9.

During its rotation in the clockwise direction relatively to the upper drum element 121, the ring gear 23 rotationally drives the lifting element 37. The lifting pegs 39 then shift within the apertures 372 and rise in the grooves 38. The transition ring 40, interdependent with the lifting pegs 39, follows the same movement, as does the lifting ring 42. The pins 41 slide within the apertures 225 of the second clutch element 217. The lifting ring 42 acts on the second clutch element 217 via the compression spring 44. The second clutch element 217 then goes from its first position to its second position.

The second clutch element 217 then acts on the balls 276 of the second row so as to place it in the corresponding housings 208 of the first clutch element 206. The balls 226 of the first row are then no longer housed in the housings 212 of the clutch ring 210. The first clutch element 206 is interlocked with the second shaft portion 213 so that they are linked in rotation.

A third and a fourth gear speed are thus selected.

D. Third Gear Speed

When the second clutch element 217 passes from its first position to its second position and when the crew member reverses the direction of rotation of the drive means in driving them in the counter-clockwise direction, the drum 13 rotates around the frame 11 at a second gear speed.

The first shaft portion 200 is driven rotationally in the counter-clockwise direction. The sun gear 202 follows the same motion. The planet gears 203 are driven rotationally in the clockwise direction. They drive the inner toothed wheel 205 and the first clutch element 206 in the same direction.

Since the first clutch element is interlocked with the second shaft portion 213, it is driven rotationally in the clockwise direction.

The third pinion 24 is driven rotationally in the clockwise direction by the second shaft portion 213.

The fourth pinion 25 is driven in the counter-clockwise direction by a third pinion 24.

The fifth pinion 26 is driven rotationally in the clockwise direction by a fourth pinion 25.

The second pinion 22 is driven rotationally in the clockwise direction via the fifth pinion 26 and the one-way clutch 27.

The drum then rotates in the clockwise direction at a third gear speed. In this embodiment, the reduction ratio of the third gear speed is equal to 0.083. In variants, it could be different.

The first pinion 19 is driven rotationally in the counter-clockwise direction by the second pinion 22. The motions of rotation of the first pinion 19 and the second shaft portion 213 are disengaged owing to the implementation of the one-way clutch 20.

E. Fourth Gear Speed

When the second clutch element 217 passes from its first position to its second position and when the crew member drives the drive means in rotation in the clockwise direction, the drum 12 rotates around the frame 11 at a fourth gear speed.

The first shaft portion 200 is driven rotationally in the clockwise direction. The sun gear 202 follows the same motion. The planet gears 203 are driven rotationally in the counter-clockwise direction. They drive the inner toothed wheel 205 and the first clutch element 206 in the same direction.

Since the second clutch element 206 is interlocked with the second shaft portion 213, this second shaft portion 213 is driven rotationally in the counter-clockwise direction.

The first pinion 19 is driven rotationally in the counter-clockwise direction via the one-way clutch 20.

The second pinion 21 is driven rotationally in the clockwise direction by the first pinion 19.

The inner ring gear 23 is driven rotationally in the clockwise direction by the second pinion 21. The drum then rotates in the clockwise direction at a fourth gear speed. In this embodiment, the reduction ratio of the fourth gear speed is equal to 0.24. In variants, it could be different.

The third pinion 24 is driven rotationally in the counter-clockwise direction by the second shaft portion 213. The fourth pinion 25 is driven rotationally in the clockwise direction by the third pinion 24. The fifth pinion 26 is driven rotationally in the counter-clockwise direction by the fourth pinion 25. The rotational motions of the fifth pinion 26 and the second pinion 21 are disengaged because of the implementation of the one-way clutch 27.

F. Selection of Setting

The value of the force applied by the line to the drum which enables the selection of the third and fourth speeds by placing the toothed wheel 23 and the second clutch element 217 in the second respective position can be adjusted by driving in the screw 35 to a greater or lesser extent into the thread 36 of the drum 12 according to the principle explained with reference to the first embodiment.

G. De-Selection

When the line is relaxed, the ring gear 23 returns to its first end position under the effect of the compression spring 30 and the second clutch element 217 resumes its first position so that when the drive means are driven rotationally in either direction, the winch will rotate at the first or the second gear speed.

H. Pumping

When the tension exerted on the line by the drum is low enough for the third and fourth gear speeds not to be engaged, the crew member can drive the drum rotationally in the first and second gear speeds in function of the direction of rotation of the drive means. He can also alternately put the drive means into rotation on a limited angular range in one direction and then in the other. He then obtains a winding of the line in pumping between the first and second gear speeds.

When the tension exerted by the line on the drum is great enough for the third and fourth gear speeds to be engaged, the crew member can drive the drum rotationally in the third and fourth gear speeds in function of the direction of rotation of the drive means. He can also pump between the third and fourth gear speeds.

When the third and fourth gear speeds are engaged, if the crew member continues to drive the drive means rotationally in the clockwise direction, he will drive the drum rotationally in the fourth gear speed. If he reverses the direction of rotation, he will drive the drum rotationally in the third gear speed.

Given the gear reduction ratios of the different gear speeds, the pumping between the first and second gear speeds is appreciably symmetrical with the pumping between the third and fourth gear speeds. Thus the amplitude of the force observed between the first and second gear speeds is appreciably equal to the amplitude of force between the third and fourth gear speeds. In other words, the contrast of the forces between the first and second gear speeds is equivalent to the contrast of the forces between the third and fourth gear speeds.

1.4. Example of a Third Embodiment of a Winch According to the Invention

1.4.1. Architecture

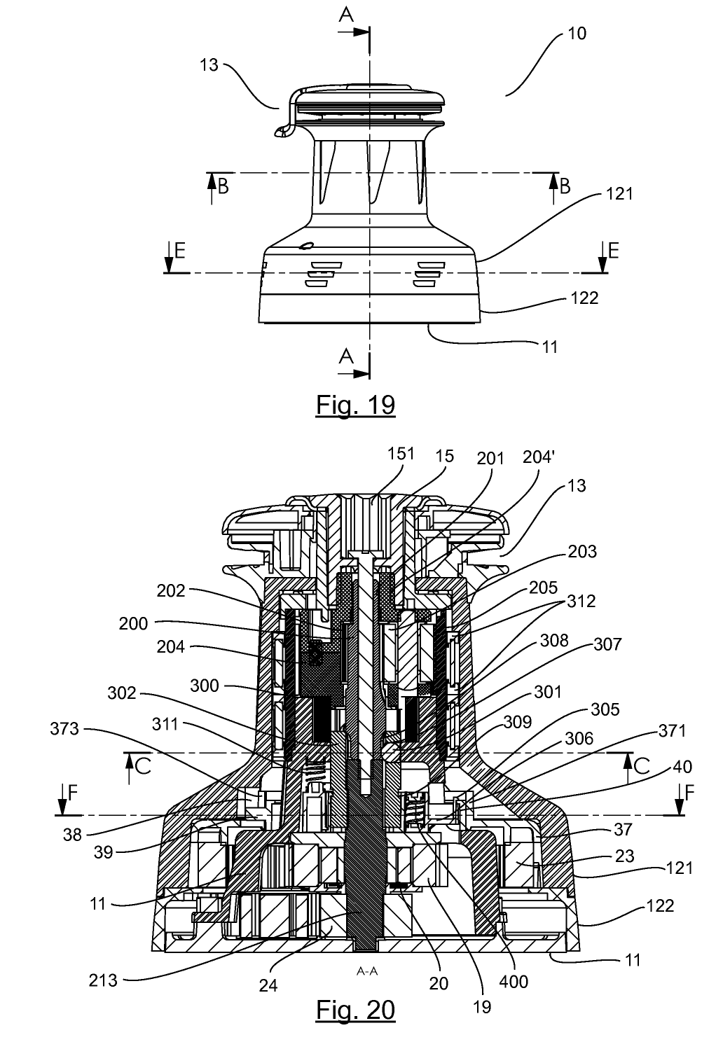

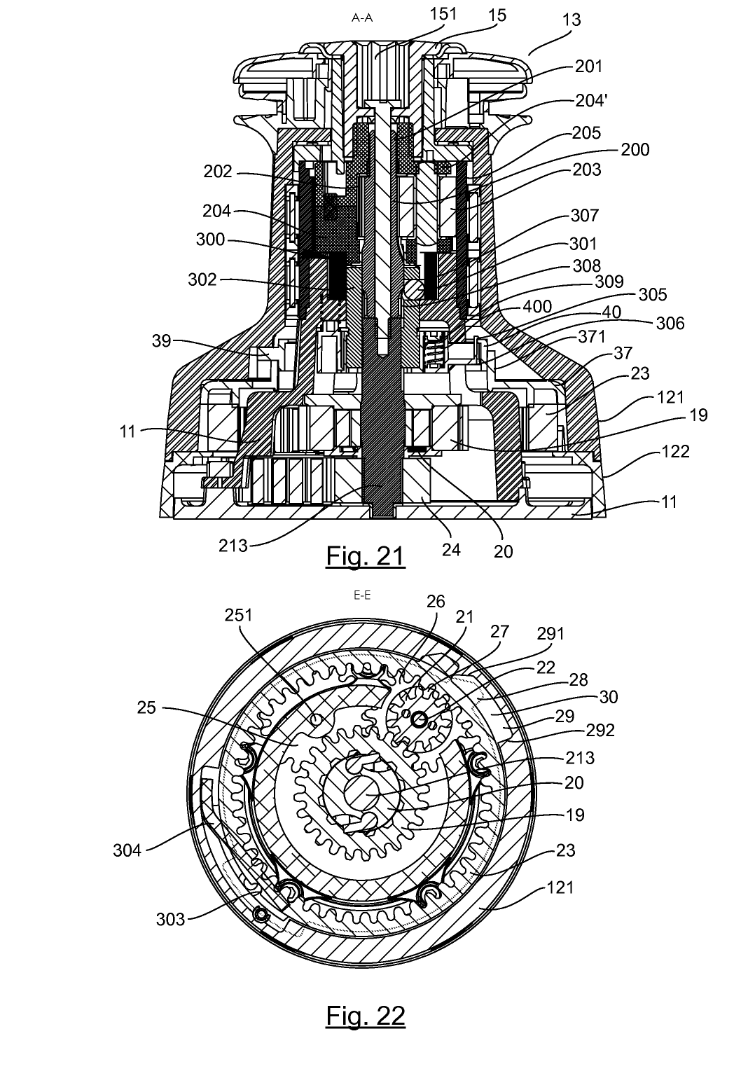

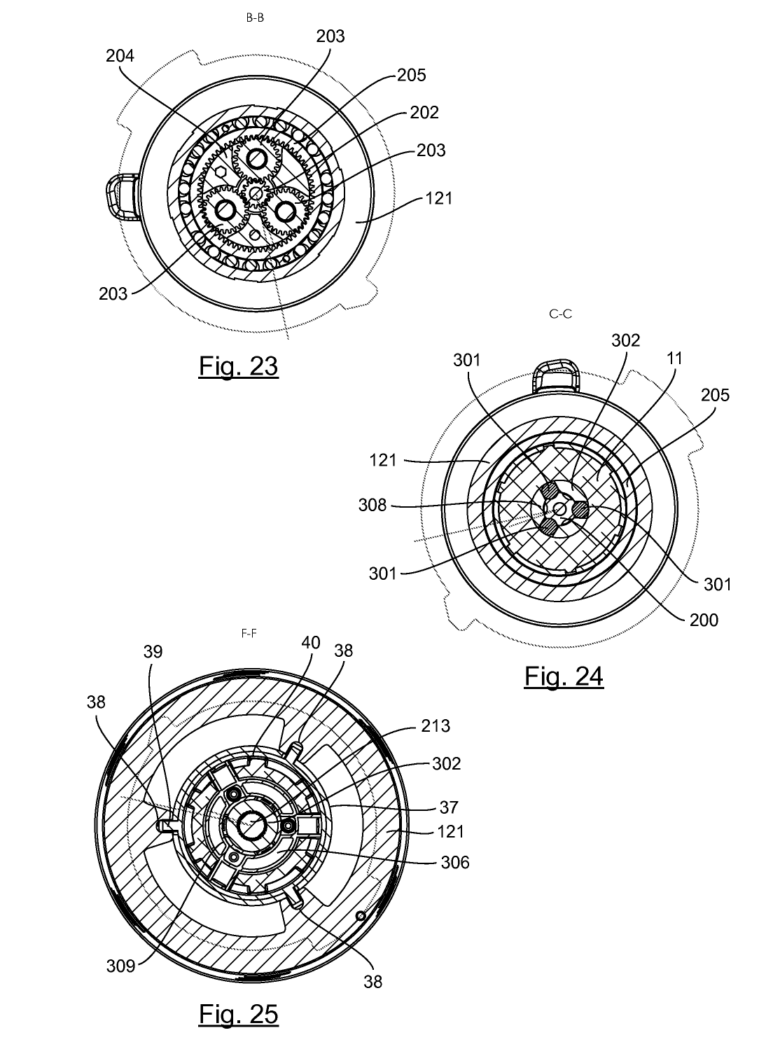

Referring now to FIGS. 19 to 25, a winch is presented according to a third embodiment of the invention.

Such a winch 10 comprises a frame 11 on which a drum 12 is mounted so as to be mobile in rotation. The frame 11 is to be fixedly attached for example to the deck of a sailing boat. A line, one end of which is linked to a sail of the sailing boat; can be wound around the drum 12. This winch 10 classically comprises a device 13 for reversibly capturing one end of the line that has to be wound around the drum 12.

The drum 12 comprises an upper drum element 121 and a lower drum element 122.

The winch comprises a first shaft portion 200 mounted so as to be mobile in rotation in the frame 11. The first shaft portion 200 comprises one upper end 201. This upper end 201 is interdependent with the input 15 of the winch. The input 15 has a splined portion 151 designed to cooperate with means for actuating the winch. These means of actuation can comprise a lever. In one variant, they could comprise a “coffee grinder”. The drive means could also be motor-driven.

The first shaft portion 200 has a pinion which constitutes the sun gear 202 of an epicyclic train. The sun gear 202 meshes with three planet gears 203 which are mounted on a planet carrier comprising an upper planet carrier element 204′ and a lower planet gear element 204 mounted rotationally on the first shaft portion 200. The planet gears 203 mesh with an inner toothed wheel 205. The epicyclic train is herein a reduction gear. In one variant, it could be a multiplier.

In one variant in which the epicyclic train is a multiplier, when the winch is actuated in first gear speed, the number of rotations made by the drum is greater than the number of rotations made by the drive means for a given number of rotations of the actuating means. A winch according to the invention therefore enables a line to be wound around the drum more speedily than with the prior-art winches, for which each gear speed has a ratio lower than 1. This winch is particularly well suited to sheet, genoa and mainsail winches. It enables tacking maneuvers without any need to grasp the sheet by hand for boarding.

In one variant, in which the epicyclic train is a reduction gear, when the epicyclic train is a reduction gear, the third and fourth gear speeds have reduction ratios of over 50% relative to the reduction ratios of the first and second gear speeds. A winch according to the invention therefore makes it possible to wind a line around the drum with half the effort of prior-art winches for which each gear speed has a reduction ratio that is lower by 50%. This winch is particularly well suited for use as a halyard winch which the sails are hoisted to the mast-head. The forces to be applied to the drive means are particularly great, at the end of the hoisting, especially because of the weight of the mainsail and the friction of the mainsail tracks. It is then often necessary to implement means for electrically driving the winches. The implementing of a reduction gear offers an alternative to electric winches.

The lower planet carrier element 204 comprises, in its lower part, coupling elements of a shape complementary to that of the coupling elements made on a transmission ring 300. The transmission ring 300 is therefore linked in rotation with the lower planet carrier element 204. Housings capable of receiving balls 301 are prepared in the lower part of the transmission ring 300.

The winch comprises a second shaft portion 213. This second shaft portion 213 is mounted so as to be rotationally mobile in the frame 11 and extends in the prolongation of the first shaft portion 200.

The second shaft portion 213 comprises, at its upper end, grooves that are complementary to the grooves formed inside a pusher element 302 of a cylindrical shape mounted on the second shaft portion 213 which is mobile in sliding along the axis of the second shaft portion 213. The pusher element 302 is therefore linked rotationally with the second shaft portion 213.

The lower part of the winch according to this third embodiment is similar to the lower part of the winches according to the first and second embodiments.

A first pinion 19 is thus mounted at the lower end of the second shaft portion 213 by means of a one-way clutch 20.

The first pinion 19 meshes with a second pinion 21 mounted rotationally on a pin 22 interdependent with the frame 11.

The second pinion 21 meshes with an inner ring gear 23 interdependent with the interior of the upper drum element 121.

A third pinion 24 is fixedly attached beneath the first pinion 19 to the lower end of the second shaft portion 213. This third pinion 24 meshes with a fourth pinion 25 mounted so as to be mobile in rotation around a pin 251 interdependent with the frame 11. This fourth pinion 25 meshes with a fifth pinion 26 which is mounted so as to be mobile in rotation on the pin 22. The fifth pinion 26 is connected to the second pinion 21 by means of another one-way clutch 27.

The ring gear 23 is mounted so as to be mobile in rotation inside the upper clutch element 121. The ring gear 23 comprises a peg 28 projecting from its periphery. This peg 28 is extended into a cavity 29 in an arc of a circle made in the lower drum element 122. This cavity 29 houses a compression spring 30. The ring gear 23 is therefore mobile in rotation inside the upper drum element 121 between two end positions:
a first position in which the compression spring 30 is relaxed so that the peg 28 abuts one end 291 of the cavity 29;
a second position in which the compression spring 30 is compressed between the peg 28 and another end 292 of the cavity 29 under the effect of the rotation of the ring gear 23 inside the upper drum element 121.

The ring 23 has a hollow housing 303 on its peripheral contour.

The lower drum element 122 comprises an elastic toe 304, the end of which gets housed in the hollow housing 303 of the ring when it occupies its first position.

A lifting element 37 is housed in a housing of a complementary shape made in the ring gear 23 so that the lifting element 37 and the ring gear 23 are linked rotationally.

The lifting element 37 comprises a cylindrical portion 371 which extends above the ring 23. Three inclined ramps 373 are made and distributed uniformly in the cylindrical portion 371.

Three grooves 38 are made and distributed uniformly inside the upper drum element 121. They extend in parallel to the axis of the first shaft portion 200.

Three lifting pegs 39 extend within the grooves 38 and the apertures 372. They are interdependent with a transition ring 40 mounted so as to be mobile in translation inside the cylindrical portion 371 along the axis of the first shaft portion 200.

The transition ring 40 is connected by locking tabs 305 to a first clutch element 306.

The first clutch element 306 is mounted so to be mobile in translation along the axis of the second shaft portion 213.

A second clutch element 309 is mounted in translation inside the first clutch element 306 along the axis of the second shaft portion 213.

Compression springs 400 are interposed between the first clutch element 306 and second clutch element 309.

The second clutch element 309 is interdependent with the pusher element 302 so that a translation of the second clutch element 309 along the second shaft portion 213 is accompanied by a translation of the pusher element 302 along the axis of the second shaft portion 213.

The periphery of the upper part of the pusher element 302 is crossed by uniformly distributed drilled holes defining housings 307 capable of receiving balls 301.

The first shaft portion 200 comprises a lower part on which there are uniformly prepared grooves 308 capable of housing the balls 301.

The pusher element 302 is mobile between:
a first position, illustrated in FIG. 20, in which it places the balls 301 in the housings 308 of the lower part of the first shaft portion 200 so that the first shaft portion 200 and the second shaft portion 213 are linked in rotation;
a second position, illustrated in FIG. 21, in which it places the balls 301 in the housings provided for this purpose of the transmission ring 300 so that the planet carrier and the second shaft portion 213 are linked in rotation.

The passage of the pusher element 302 from its first position to its second position is obtained during the passage of the ring gear 23 from its first position to its second position. During this movement of the ring gear 23, the ramps 373 act on the pegs 39 so that the transition ring 40 rises along the axis of the second shaft portion 213. In a same movement, the transition ring 40 drives the first clutch element 306 counter to the effect of the compression springs 311 placed between the frame 11 and the first clutch element 306. The first clutch element 306 drives the second clutch element 309 in a same movement via the compression springs 400. The second clutch element 309 drives the pusher element 302 in a same movement. The balls 301 then leave the housings 308 of the first shaft portion 200 to get housed in the housings provided for this purpose in the transmission ring 300.

The passage of the pusher element 302 from its second to its first position is obtained during the passage of the ring gear 23 from its second position to its first position. During the movement of the ring gear 23, the ramps 373 act on the pegs 39 so that the transition ring 40 re-descends along the axis of the second shaft portion 213. The first clutch element 306 follows the same movement under the effect of the compression springs 311. The second clutch element 309 follows the same movement via the compression springs 400. The second clutch element 309 drives the pusher element 302 in the same movement. The balls 301 then leave the housings provided for this purpose in the transmission ring 300 to get housed in the housings 308 of the first shaft portion 200.

Needle roller cage assemblies 312 are interposed between the ring gear 205 and the upper drum element 121 so as to ensure the guiding of the drum 12 in rotation relative to the frame 11.

1.4.2. Operation

The working of the winch according to this third embodiment is appreciably the same as the working of the winch according to the second embodiment.

At the start of the winding of a line around the drum, the tension exerted by the line on the drum is low so that the ring gear 23 occupies its first position and the pusher element 302 occupies its first position.

When the drive means which cooperate with the splined portion 151 are driven in rotation in the counter-clockwise direction, the first shaft portion 200 rotates in the counter-clockwise direction. The second shaft portion 213 is interlocked with the first shaft portion 200 via the balls 301 and the pusher element 302. The drum is then driven in rotation in the clockwise direction in a first gear speed.

A reversal of the direction of rotation of the drive means drives the drum rotationally in the clockwise direction in a second gear speed.

When the force applied to the drum 12 by the line wound around it becomes greater than the sum of the effort applied to the drum 12 by the crew member via the actuating means and the different gear transmission units by which they are linked to the ring gear 23 and of the frictional force exerted by the elastic toe 304 on the ring gear 23, the ring gear 23 rotates within the upper drum element 121, countering the effect of the compression spring 30 until it reaches its second end position in which the peg 28 completely compresses the spring 30 against the end 292 of the cavity 29.

The ring gear 23 passes from its first end position illustrated in FIG. 20 to its second end position illustrated in FIG. 21. The pusher element 302 passes from its first position to its second position.

The first shaft portion 200 and the second shaft portion 213 are no longer directly linked in rotation. The transmission between the first shaft portion 200 and the second shaft portion 213 is provided by the epicyclic train, the planet carrier being linked to the second shaft portion 213 via the pusher element 302 and the balls 301.

A third gear speed and a fourth gear speed are thus selected.

When the drive means are driven rotationally in the clockwise direction, the drum is driven rotationally in the clockwise direction in a third gear speed.

A reversal of the direction of rotation of the drive means drives the drum in rotation in the clockwise direction in a fourth gear speed.

The de-selection of the third and fourth gear speeds is obtained automatically when the effort exerted by the line on the drum is sufficiently reduced.

The winch according to the third embodiment can work in pumping mode.

Adjusting means can be planned to act on the stiffness of the elastic toe 304 so as to adjust the effort as of which the third and fourth gear speeds are selected. The elastic toe and the hollow housing of the ring gear could be replaced by a ramp and toe system as the one described in the previous embodiments.

An embodiment of the invention overcomes drawbacks of the prior art.

At least one embodiment provides a winch that can be used to adapt at least one gear speed to the tension in the line wound around it.

At least one embodiment provides a winch of this kind that enables a crew member to pass automatically from pumping between a first and a second gear speed to pumping between the second and a third gear speed solely by reversing the direction of rotation of the lever.

At least one embodiment of the invention provides a winch of this kind in which it is possible to adapt the passage from a pumping between the first and second gear speed to pumping between the second and third gear speed to the crew member's strength.

At least one embodiment implements a winch of this kind in which the selection of at least one gear speed is obtained automatically given the tension of a line wound around it.

At least one embodiment provides a capstan or winch in which the passage from one gear speed to another is obtained solely by acting on the lever without its being necessary to actuate another command means such as a push-button.

At least one embodiment provides a winch of this kind that is compact.

At least one embodiment provides a winch that is ergonomical.

At least one embodiment provides a winch of this kind that is a low-cost winch.

1. A winch intended to be fixedly attached to a sailing boat in order to tension a line connected to a sail, said winch comprising:
a fixed frame housing a shaft and a gearbox;
a drum around which said line can be wound, said drum being mounted so as to be mobile in rotation in only one direction around said frame and connected to said shaft via said gearbox, wherein a putting of said shaft into rotation is accompanied by a putting of said drum into rotation around said frame;
means for evaluating tension of said line;
means for selecting at least one gear speed when said tension becomes above a predetermined threshold, said gearbox comprising an inner ring gear; and
at least one of means for exerting a frictional force or means for exerting an elastic return force on said ring gear, said ring gear being mounted so as to be mobile in rotation inside said drum against an effect of said means exerting a frictional force and/or said means for exerting an elastic return force on said ring gear so that said ring gear can rotate relative to said drum when said tension is above said threshold.

2. The winch according to claim 1, wherein said means for selecting are mobile between at least one resting position and one position for selecting at least one gear speed, said ring gear acting on said means for selecting automatically to place them in either one of their positions.

3. The winch according to claim 2, wherein the winch comprises means for converting a shift of said ring gear relative to said drum into a movement of said means for selecting either one of their positions.

4. The winch according to claim 1, wherein the winch comprises means for adjusting said threshold value.

5. The winch according to claim 1 wherein said ring gear has a contact surface with a ramp and said means exerting a frictional force on said drum comprise a toe interdependent with said drum and taking support on said contact surface under the effect of said elastic return means.

6. The winch according to claim 4, wherein said means for adjusting comprise a screw having a base and a head, said return means being interposed between said toe and said base, said head being accessible from outside said drum.

7. The winch according to claim 1 wherein said ring gear has a hollow housing and said means exerting a frictional force on said drum comprise an elastic toe that is interdependent with said drum and has its end capable of getting housed in said hollow housing.

8. The winch according to claim 1, wherein said gearbox is a three-speed gearbox, said means for selecting automatically being means for selecting the third gear speed and the putting of said shaft into rotation in one direction or the other is accompanied by the putting of said drum into rotation around said frame in one speed or another.

9. The winch according to claim 8, wherein the first gear speed of said gearbox has a multiplication ratio, the second and third gear speeds having reduction ratios.

10. The winch according to claim 1, wherein said means for selecting are means for selecting a third gear speed and a fourth gear speed.

11. The winch according to claim 1, wherein said shaft comprises a first shaft portion and a second shaft portion, said second shaft portion being connected to said ring gear by a plurality of gears so that a rotation of said second shaft portion in one direction or in the other drives a rotation of said drum in one direction at two different transmission ratios, said first shaft portion being connected to at least one gear train, said means for selecting interlocking directly said first shaft portion with said second shaft portion when they occupy one of their positions, said means for selecting interlocking said first shaft portion with said second shaft portion via one of said gear trains when they occupy another of their positions.

12. The winch according to claim 1, wherein said shaft is connected to said ring gear by a plurality of gears so that a rotation of said shaft in one direction or the other drives a rotation of said drum in one direction at two different transmission ratios, said shaft being furthermore connected to the input of a multiplier gear train, the output of which is connected to the input of the plurality of gears by a one-way clutch, said means for selecting interlocking the output of said multiplier gear train with the input of the plurality of gears when they occupy their resting position, said means for selecting not interlocking the output of said multiplier gear train with the input of the plurality of gears when they occupy their other position.

13. The winch according to claim 1, wherein said shaft has a first end to which drive means can be connected, said gearbox having a first pinion connected by a first one-way clutch to a second end of said shaft, said first pinion meshing with a second pinion mounted so as to be rotationally mobile on a first pin interdependent with said frame, said second pinion meshing with an inner ring gear interdependent with said drum, a third pinion being interdependent with said second end of said shaft, said third pinion meshing with a fourth pinion mounted so as to be rotationally mobile around a second pin interdependent with said frame, said fourth pinion meshing with a fifth pinion connected to said first pin by a second one-way clutch, said winch furthermore comprising a multiplier having an input connected to said shaft and an output connected to the first pinion by a third one-way clutch, said means for selecting automatically being capable of taking a position for holding said third one-way clutch in disengaged position when said tension is above said threshold, the first, second and third one-way clutches being configured so that a rotation in a first direction of said shaft enables the shaft to transmit a torque to said ring gear via said multiplier, said third one-way clutch, said first and said second pinions, so that a rotation of said shaft in another direction enables the shaft to transmit a torque to said ring gear via the first and second pinions, and so that a rotation in said first direction of said shaft while said tension is above said threshold enables it to transmit a torque to said ring gear via the third, fourth and fifth pinions.

14. The winch according to claim 13, wherein said ring gear is mounted so as to be mobile in rotation between two end positions inside said drum, countering the effect of said elastic return means, said ring gear acting on said means for selecting automatically so that the passage from one of said end positions to the other of the ring gear, countering the effect of said return means, is accompanied by the passage of said means for selecting into said holding position.

15. The winch according to claim 13, wherein said multiplier, said third one-way clutch and said means for selecting automatically are detachable.

16. The winch according to claim 1, wherein the winch comprises means for actuating said shaft, said actuating means comprising a coffee grinder or a lever, one end of which complements said first end of said shaft.
